(19) United States
(12) Patent Application Publication
(10) Pub. No.: US 2024/0427694 A1
(43) Pub. Date: Dec. 26, 2024

(54) FAULT LOCALIZATION USING DOUBLE N-WISE COMBINATORIAL TESTING WITH CONSTRAINTS

(71) Applicant: International Business Machines Corporation, Armonk, NY (US)

(72) Inventors: Dale E. Blue, Poughkeepsie, NY (US); Andrew C. M. Hicks, Highland, NY (US); Ryan Thomas Rawlins, New Paltz, NY (US); Eitan Daniel Farchi, Pardes Hana (IL)

(21) Appl. No.: 18/213,663

(22) Filed: Jun. 23, 2023

(51) Int. Cl. G06F 11/36

(52) U.S. Cl. CPC G06F 11/3684; G06F 11/3688

(57) ABSTRACT

A computer-implemented method, in accordance with one embodiment, includes generating a set of test cases for a system under test (SUT). The set of test cases is augmented by locating a missing counterpart for a first combination of values in a first test case based on identifying a number of instances of the first combination of values in the set of test cases, generating a new test case based on modifying the first test case to act as the missing counterpart, determining whether the new test case violates a constraint from a set of predefined constraints, in response to determining that the new test case violates the constraint, modifying at least one of the values in the new test case, and adding the modified new test case to the set of test cases. A fault for the SUT is identified based on executing the augmented set of test cases.

### BACKGROUND

The present invention relates to fault detection, and more specifically, this invention relates to self-diagnosing fault detection using combinatorial testing.

Combinatorial Test Design (CTD) has proven useful in creating optimized test suites for software testing. A CTD model is created that identifies the attributes to be tested, and the possible values for each attribute. Using the CTD model, an optimized test suite (test solution) is created that ensures test coverage across interactions between attributes of the test. Each test in the test suite may cover interactions across multiple possible test attribute/value pairs.

When a bug is discovered using CTD, additional testing is required thereafter to determine which attribute/value pair or combination of attribute/value pairs in the failing test is/are responsible for revealing the bug. A drawback of this approach, however, is that tests are generated after the bug is found, thereby requiring additional processing power to perform test generation and fault localization after a bug is discovered.

### SUMMARY

A computer-implemented method, in accordance with one embodiment, includes generating a set of test cases for a system under test (SUT), the set of test cases being based on attribute-value pairs modeled as input to the SUT. The set of test cases is augmented by locating a missing counterpart for a first combination of values in a first test case in the set of test cases based on identifying a number of instances of the first combination of values in the set of test cases, generating a new test case based on modifying the first test case to act as the missing counterpart, determining whether the new test case violates a constraint from a set of predefined constraints, in response to determining that the new test case violates the constraint, modifying at least one of the values in the new test case, and adding the modified new test case to the set of test cases. A fault for the SUT is identified based on executing the augmented set of test cases.

A computer-implemented method, in accordance with another embodiment, includes generating a set of test cases for a system under test (SUT), the set of test cases being based on attribute-value pairs modeled as input to the SUT. The set of test cases is augmented by locating missing counterparts for combinations of values in multiple test cases in the set of test cases based on identifying numbers of instances of the combinations of values in the set of test cases, generating new test cases based on modifying the test cases having missing counterparts to act as the missing counterparts, and adding the new test cases to the set of test cases. A determination is made as to whether one or more of the test cases in the augmented set of test cases violates one or more constraints from a set of predefined constraints. In response to determining that one of the test cases in the augmented set of test cases violates one or more of the constraints, at least one of the values in the one of the test cases is modified. A fault for the SUT is identified based on executing the augmented set of test cases.

A computer program product, in accordance with various embodiments, includes one or more computer readable storage media, and program instructions collectively stored on the one or more computer readable storage media, the program instructions comprising program instructions to perform any of the foregoing methodology.

A system, in accordance with various embodiments, includes a processor, and logic integrated with the processor, executable by the processor, or integrated with and executable by the processor, the logic being configured to perform any of the foregoing methodology.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A illustrates a block diagram of fault detection using combinatorial testing, in accordance with one embodiment.

FIG. 2B illustrates an example test vector, in accordance with one embodiment.

FIG. 2C illustrates n-wise expansion of test cases for fault detection using combinatorial testing, in accordance with one embodiment.

FIG. 3 is a block diagram illustrating generating augmented n-wise test cases for self-diagnosing fault detection using combinatorial testing, in accordance with one embodiment.

FIG. 4 is a flowchart illustrating identifying fault using combinatorial testing, in accordance with one embodiment.

FIG. 5 is a block diagram illustrating generating augmented n-wise test cases for self-diagnosing fault detection using combinatorial testing and constraints, in accordance with one embodiment.

FIG. 6 is a flowchart of a method for augmenting a set of test cases in accordance with constraints, in accordance with one embodiment.

FIG. 7 is a block diagram illustrating generating augmented n-wise test cases for self-diagnosing fault detection using combinatorial testing and constraints, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for self-diagnosing fault detection using double n-wise combinatorial testing with constraints.

In one general embodiment, a computer-implemented method includes generating a set of test cases for a system under test (SUT), the set of test cases being based on attribute-value pairs modeled as input to the SUT. The set of test cases is augmented by locating a missing counterpart for a first combination of values in a first test case in the set of test cases based on identifying a number of instances of the first combination of values in the set of test cases, generating a new test case based on modifying the first test case to act as the missing counterpart, determining whether the new test case violates a constraint from a set of predefined constraints, in response to determining that the new test case violates the constraint, modifying at least one of the values in the new test case, and adding the modified new test case to the set of test cases. A fault for the SUT is identified based on executing the augmented set of test cases.

In another general embodiment, a computer-implemented method includes generating a set of test cases for a system under test (SUT), the set of test cases being based on attribute-value pairs modeled as input to the SUT. The set of test cases is augmented by locating missing counterparts for combinations of values in multiple test cases in the set of test cases based on identifying numbers of instances of the combinations of values in the set of test cases, generating new test cases based on modifying the test cases having missing counterparts to act as the missing counterparts, and adding the new test cases to the set of test cases. A determination is made as to whether one or more of the test cases in the augmented set of test cases violates one or more constraints from a set of predefined constraints. In response to determining that one of the test cases in the augmented set of test cases violates one or more of the constraints, at least one of the values in the one of the test cases is modified. A fault for the SUT is identified based on executing the augmented set of test cases.

A computer program product, in accordance with various embodiments, includes one or more computer readable storage media, and program instructions collectively stored on the one or more computer readable storage media, the program instructions comprising program instructions to perform any of the foregoing methodology.

A system, in accordance with various embodiments, includes a processor, and logic integrated with the processor, executable by the processor, or integrated with and executable by the processor, the logic being configured to perform any of the foregoing methodology.

### Exemplary Computer Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for double n-wise combinatorial testing with constraints in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

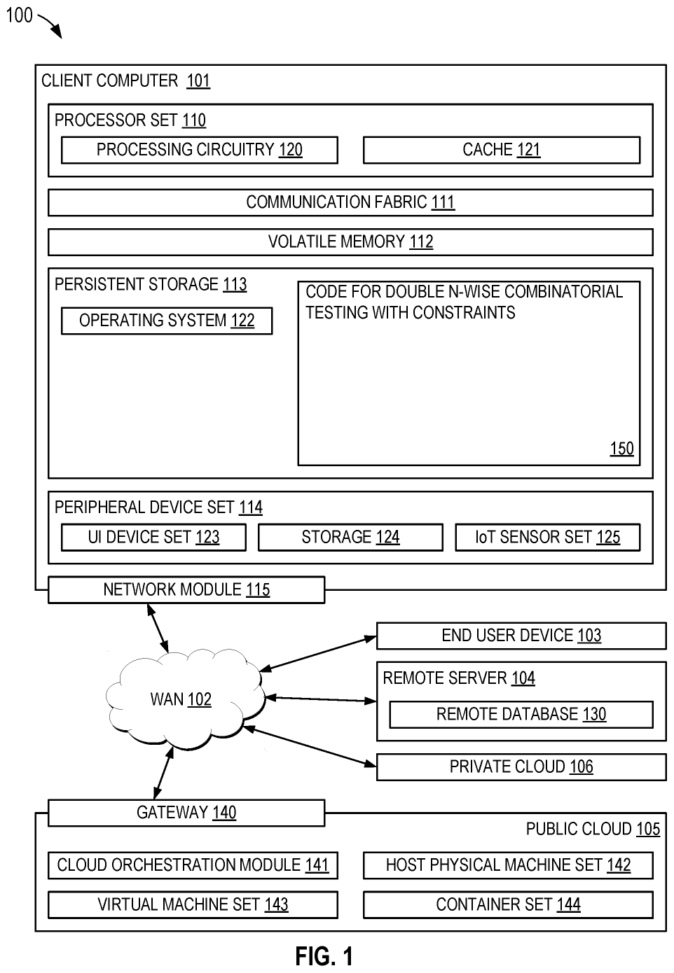

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

Double n-Wise Test Solution

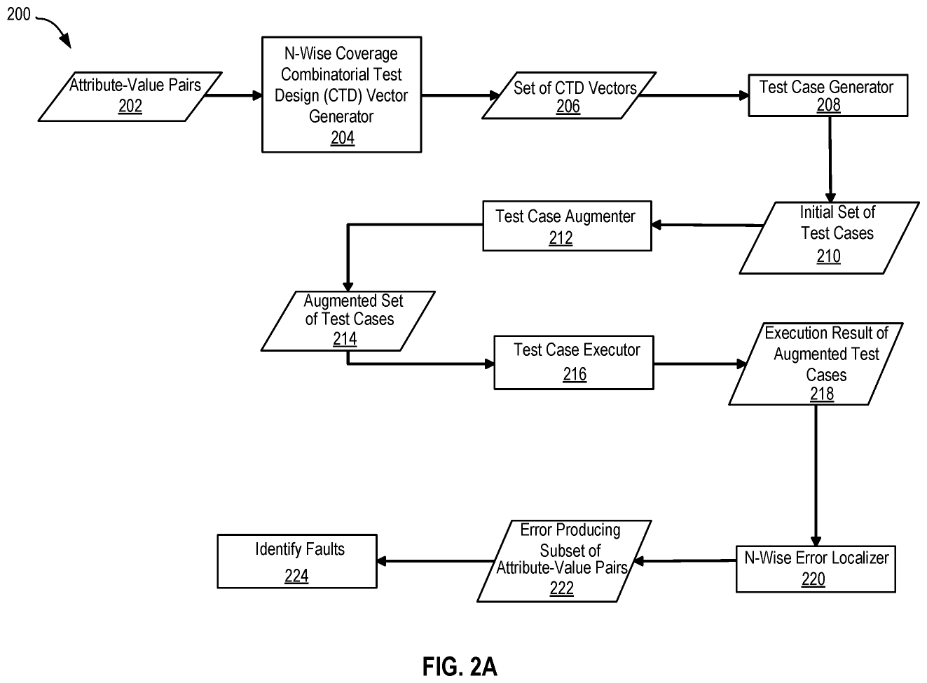

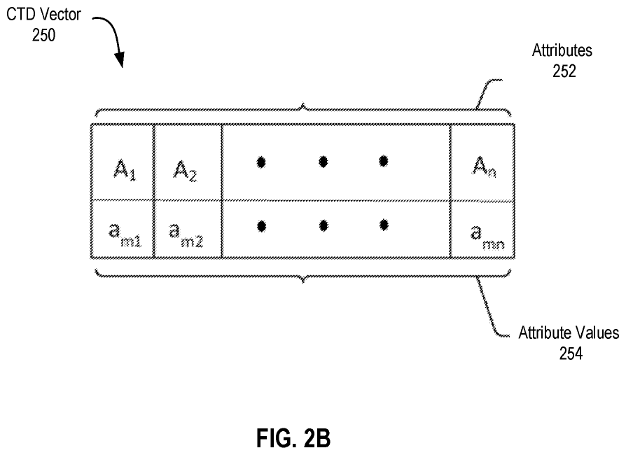

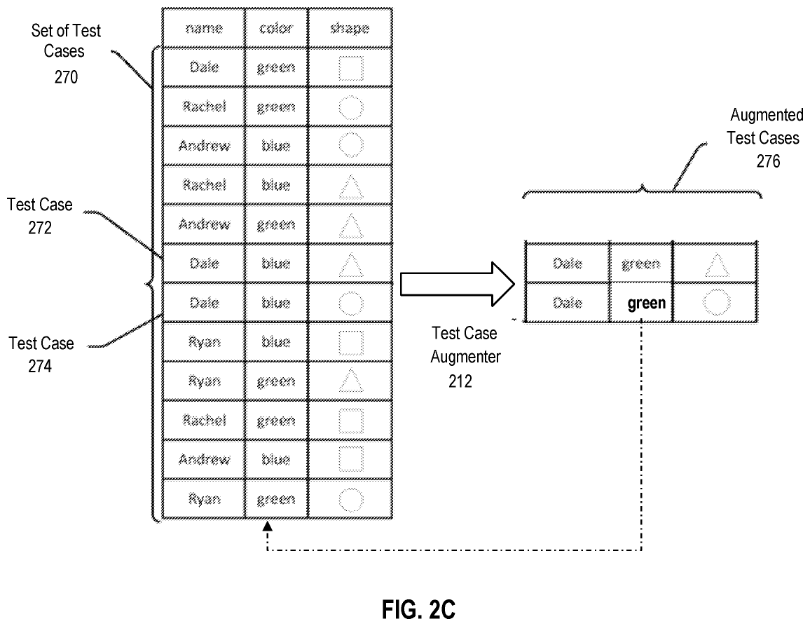

FIG. 2A illustrates a block diagram 200 of fault detection using combinatorial testing, according to one embodiment. The method depicted in the diagram 200 may be performed in accordance with the present invention in any of the environments depicted in FIG. 1, among others, in various embodiments. Of course, more or fewer operations than those specifically described in FIG. 2 may be included in the method depicted in the diagram 200, as would be understood by one skilled in the art upon reading the present descriptions.

Each of the steps of the method depicted in the diagram 200 may be performed by any suitable component of the operating environment. For example, in various embodiments, the method depicted in the diagram 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method depicted in the diagram 200. Illustrative processors include, but are not limited to, a central processing unit (CPU), an application specific integrated circuit (ASIC), a field programmable gate array (FPGA), etc., combinations thereof, or any other suitable computing device known in the art.

In an embodiment, inputs to a SUT are modeled as a collection of attribute-value pairs 202. Any number of attributes may be used to model SUT inputs and each attribute may take on any number of candidate attribute values. An n-wise coverage CTD vector generator 204 takes the attribute-value pairs 202 and generates a set of CTD vectors 206. For example, the set of CTD vectors 206 can provide n-wise coverage of an entire Cartesian product space associated with the collection of attribute-value pairs 202, where n may be an integer of 2, 3, 4 or more.

In particular, the entire Cartesian product space that contains all possible combinations of the attribute-value pairs 202 is reduced to a smaller set of CTD vectors 206 that provides complete n-wise coverage of the entire test space. In exemplary embodiments, the complete n-wise coverage provided by the set of CTD vectors 206 may be complete pairwise coverage (n=2). For instance, if it is assumed that three attributes are modeled, namely, a “name” attribute, a “color” attribute, and a “shape” attribute as shown in FIG. 2C, and if it is further assumed that the “name” attribute can take on four distinct values (Dale, Rachel, Andrew, and Ryan), the “color” attribute can take on two distinct values (green, blue), and the “shape” attribute can take on three distinct values (circle, square, triangle), then the total number of possible combinations of attribute-value pairs would be 4*3*2-24. Thus, in this illustrative example, the entire Cartesian product space would include 24 different combinations of attribute-value pairs. In example embodiments, these 24 different combinations of attribute-value pairs are reduced down to a smaller set of combinations (i.e., the set of CTD vectors 206) that still provides complete n-wise coverage of the Cartesian product space. For instance, if complete pairwise coverage is sought, then the 24 different combinations can be reduced down to 12 distinct combinations that together include every possible pairwise interaction of attribute values. An example set of test cases 270 is shown in FIG. 2C. The example set of test cases 270 includes all pairwise interactions between the attribute values of the attributes “name,” “color,” and “shape.”

In example embodiments, a binary decision diagram or the like may be used to perform the reduction and identify the reduced set of CTD vectors 206 that provides complete n-wise coverage. While each CTD vector in the set of CTD vectors 206 includes a unique combination of attribute values, the set of CTD vectors 206 itself may not be unique. That is, there may be multiple possible different sets of CTD vectors, each of which provides complete n-wise coverage.

FIG. 2B depicts an example generic CTD vector 250 of the type that may be included in the set of CTD vectors 206, according to one embodiment. The example CTD vector 250 includes a plurality of attributes 252. The attributes 252 may be used to model inputs to a SUT. The attributes 252 may be associated with attribute values 254. In particular, each attribute 252 may have a corresponding attribute value 254, which may be one of one or more candidate attribute values that the attribute is allowed to take on.

Returning to FIG. 2A, in an embodiment, a test case generator 208 generates, from the set of CTD test vectors 206, a corresponding initial set of test cases 210. For instance, the set of CTD test vectors 206 may be provided as input to a test case generation tool configured to generate a respective corresponding test case for each CTD vector. Each test case in the set of test cases 210 may be designed to test the interactions among the particular combination of attribute values contained in a corresponding CTD vector of the set of CTD vectors 206. It should be appreciated that a set of CTD vectors and their corresponding test cases may, at times, be described herein and/or depicted interchangeably. For instance, the example set of test cases 270 may be interchangeably thought of as a set of CTD test vectors.

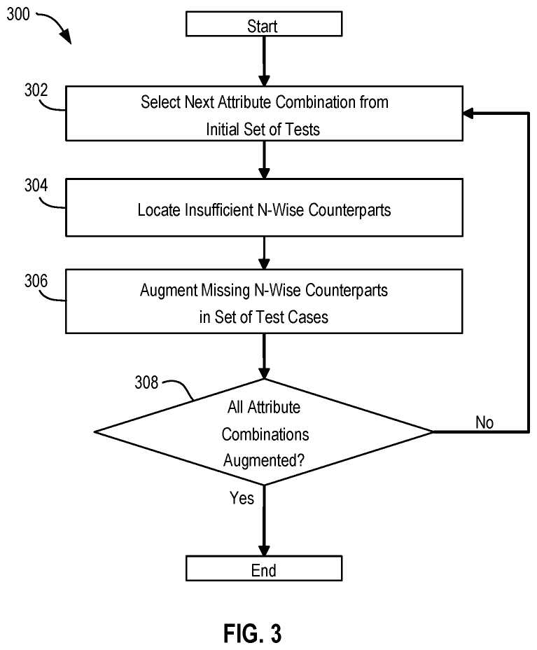

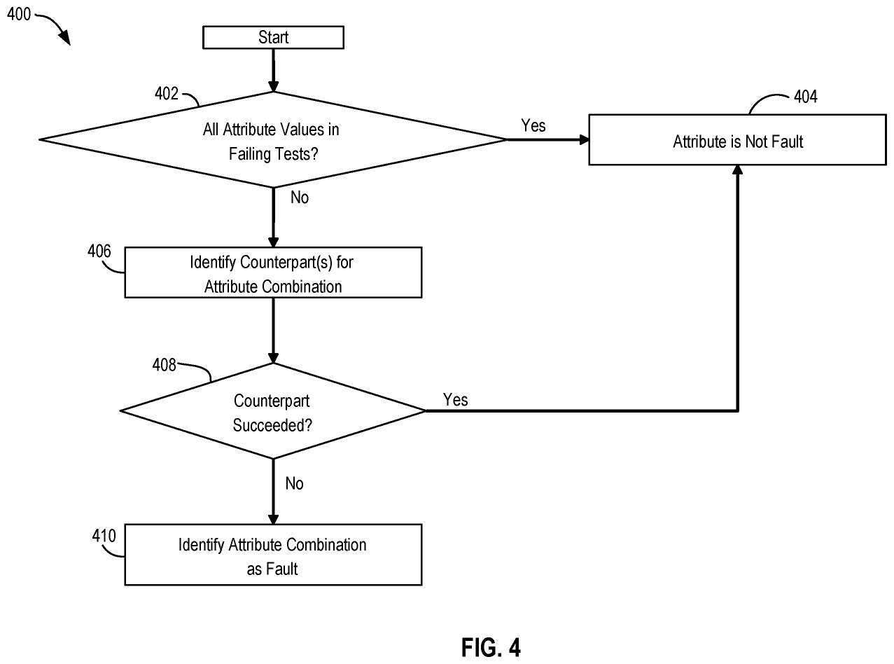

In an embodiment, the initial set of test cases 210 is provided to a test case augmenter 212. In an embodiment, the test case augmenter 212 identifies n-wise combinations of attributes (e.g., pairwise combinations of attributes) that are lacking sufficient counterparts to automatically identify faults. This is discussed further, below, with regard to FIG. 3. The test case augmenter 212 generates an augmented set of test cases 214 that can be used to identify faults. This is discussed further, below, with regard to FIG. 4.

A test case executor 216 is executed to determine whether any test cases in the augmented set of test cases 214 failed. In example embodiments, execution of each test case 214 results in either a successful execution result, indicating that the combination of attribute values contained in the corresponding CTD vector 206 does not contain an n-wise (or m-wise where m<n) error, or a failure execution result, indicating that the combination of attribute values in the corresponding CTD vector 206 does contain an n-wise (or m-wise where m<n) error.

Referring to the example depicted in FIG. 2C, a set of test cases 270 are executed to yield a respective execution result for each test case. In particular, two test cases 272 and 274 are illustratively depicted in FIG. 2C. Assume the test cases 272 and 274 are failing tests. The test case 272 tests the following combination of attribute values: Dale; blue; triangle, which respectively correspond to the attributes name, color, and shape. The test case 274 tests the following combination of attribute values: Dale; blue; circle, which respectively correspond to the attributes name, color, and shape. Although “Dale” and “blue” are present both in the CTD vector corresponding to the test case 272 and in the CTD vector corresponding to the test case 274, it is unclear, based on these test cases, whether “Dale” and “blue” are generating a pairwise error; whether “Dale” and (“triangle” or “circle”) are generating the pairwise errors; or whether “blue” and (“triangle” or “circle”) are generating the pairwise errors.

In an embodiment, the test case augmenter 212 can be used to generate augmented test cases 276. The augmented test cases 276 include pairwise counterparts to ensure that each pairwise combination of attributes (e.g., in the test cases 272 and 274) includes a counterpart. For example, the augmented test cases ensure that all of <Dale, blue>, <Dale, triangle>, <Dale, circle>, <blue, triangle>, and <blue, circle> appear at least twice in the augmented set of test cases. This is discussed further, below, with regard to FIG. 3. Further, while the augmented test cases 276 illustrate augmented examples for the test cases 272 and 274, in an embodiment the test cases augmenter 212 creates suitable augmented test cases for the complete set of test cases relating to the set of test cases 270. That is, the augmented test cases 276 represent an intermediate result, for illustration purposes. As discussed below in relation to FIG. 3, the test case augmenter 212 can generate additional augmented test cases to ensure that each pair in the set of test cases 270 includes a suitable counterpart.

Returning to FIG. 2A, the test case executor 216 generates execution results 218 from the augmented set of test cases 214. One or more n-wise error localizers 220 are executed to detect and localize an error (e.g., n-wise or lesser order error) based on the attributes and their corresponding failing attribute values in their n-wise counterpart(s), including augmented counterpart(s) generated by the test case augmenter 212. This is discussed further, below, with regard to FIG. 4.

Returning again to FIG. 2A, the error producing subset of attribute-value pairs 222 can be used to identify faults. For example, the attribute-value pairs 222 identify one or more attributes that led to faults identified with the test case executor 216. This can be used to identify faults 224 and take appropriate action to identify or resolve the fault, including providing an alert, allowing for automated correction, or taking any other suitable action.

FIG. 3 is a flowchart 300 illustrating generating augmented n-wise test cases for self-diagnosing fault detection using combinatorial testing, according to one embodiment. The method depicted in the flowchart 300 may be performed in accordance with the present invention in any of the environments depicted in FIGS. 1-2, among others, in various embodiments. Of course, more or fewer operations than those specifically described in FIG. 3 may be included in the method depicted in the flowchart 300, as would be understood by one skilled in the art upon reading the present descriptions.

Each of the steps of the method depicted in the flowchart 300 may be performed by any suitable component of the operating environment. For example, in various embodiments, the method depicted in the flowchart 300 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method depicted in the flowchart 300. Illustrative processors include, but are not limited to, a CPU, an ASIC, an FPGA, etc., combinations thereof, or any other suitable computing device known in the art.

In an embodiment, FIG. 3 provides example techniques for the test case augmenter 212 illustrated in FIG. 2A and discussed above. At block 302, a fault localization service selects a next attribute combination from an initial set of CTD test cases (e.g., the initial set of test cases 210 illustrated in FIG. 2A).

For example, using the example depicted in FIG. 2C, the test case 272 includes the attribute values <Dale, blue, triangle>. The fault localization service identifies the test case 272, and selects a next pair of attributes (e.g., the name attribute “Dale” and the color attribute “blue” or the shape attribute “triangle”). In an embodiment, the fault localization service uses any suitable technique to identify the next pair of attributes.

At block 304, the fault localization service locates insufficient n-wise counterparts. In an embodiment, the goal of the fault localization service is to generate additional test cases so that each combination of attributes, in an initial set of CTD test cases, has a respective counterpart that can be used to identify fault (e.g., as discussed below in relation to FIG. 4). The fault localization service locates, for the selected attribute pair, insufficient n-wise combinations with other attributes.

For example, assume a pairwise implementation uses the test cases illustrated in FIG. 2C. The fault localization service selects the attribute pair “Dale” and “blue” from the test case 272 that includes the attribute values <Dale, blue, triangle>. The fault localization service identifies whether “Dale” and “blue” has a counterpart in the set of test cases.

For example, in the example pairwise implementation, the fault localization service ensure that there are at least two instances of <Dale, blue> in the set of test cases 270. As illustrated, the set of test cases 270 includes two instances of <Dale, blue>: <Dale, blue, triangle> (e.g., in the test case 272) and <Dale, blue, circle> (e.g., in the test case 274). Thus, the combination <Dale, blue> is not missing a counterpart.

Assume, however, that the fault localization service selects the attribute pair “Dale” and “triangle” from the test case 272. The set of test cases 270 includes only one instance of <Dale, triangle> (e.g., the test case 272). Thus, the fault localization service identifies <Dale, triangle> as a missing pairwise counterpart. As noted, this is merely an example, and the fault localization service can identify any n-wise missing combinations.

At block 306, the fault localization service augments the missing n-wise test counterparts in the set of test cases. For example, as noted above the fault localization service identifies <Dale, triangle> as a missing pairwise counterpart from the test case 272. In an embodiment, the fault localization service augments the set of test cases by adding an additional test in which another attribute, other than <Dale, triangle>, is changed from the test case 272. In an embodiment, any attribute other than the pair under analysis can be changed, and this attribute can be changed to have any valid value. Thus, the fault localization service generates the new test case <Dale, green, triangle>, and adds this test case to the set of test cases 270. See FIG. 2C.

At block 308, the fault localization service determines whether all attributes have been augmented (e.g., for a given failed test). If so, the flow ends. If not, the flow returns to block 302 and the fault localization service selects the next attributes.

For example, using the example of the test case 272 illustrated in FIG. 2C, the fault localization service determines that all attribute combinations have not been augmented (e.g., only the pair <Dale, blue> or <Dale, triangle> has been augmented). The fault localization service selects the next attribute pair (e.g., the color attribute “blue” and the shape attribute “triangle”) and proceeds with blocks 302-306, identifying whether <blue, triangle> is missing a counterpart, and augmenting appropriately.

In an embodiment, the fault localization service uses the augmented set of test cases, including test cases added by the previous pass through blocks 302-306 (e.g., including the addition of <Dale, green, triangle> as discussed above), to identify missing counterparts. Building the set of test cases in this way can have significant advantages, because each iteration through blocks 302-306 adds augmented counterparts that apply to not only the pair under analysis, but potentially other pairs as well. For example, adding <Dale, green, triangle>, as discussed above, adds a counterpart for <Dale, triangle>. But it also adds a counterpart for <Dale, green>, and for <green, triangle>. If either of those attribute pairs was previously missing a counterpart in the set of test cases, the counterpart will no longer be missing. Thus, the number of augmented test cases drops significantly as the fault localization service iterates through the attribute combinations at blocks 302-306.

Further, in an embodiment, the techniques illustrated in FIG. 3 are applied to each test case in the set of test cases. For example, these techniques can be applied to the test case 274, resulting in the addition of the test case <Dale, green, circle> to augment the missing pairwise combination <Dale, circle>.

FIG. 4 is a flowchart 400 illustrating identifying fault using combinatorial testing, according to one embodiment.

The method depicted in the flowchart 400 may be performed in accordance with the present invention in any of the environments depicted in FIGS. 1-3, among others, in various embodiments. Of course, more or fewer operations than those specifically described in FIG. 4 may be included in the method depicted in the flowchart 400, as would be understood by one skilled in the art upon reading the present descriptions.

Each of the steps of the method depicted in the flowchart 400 may be performed by any suitable component of the operating environment. For example, in various embodiments, the method depicted in the flowchart 400 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method depicted in the flowchart 400. Illustrative processors include, but are not limited to, a CPU, an ASIC, an FPGA, etc., combinations thereof, or any other suitable computing device known in the art.

In an embodiment, FIG. 4 provides example techniques for the n-wise error localizer 220 illustrated in FIG. 2A and discussed above. In an embodiment, as illustrated in FIG. 2A, the techniques in FIG. 4 are used to assess execution results 218 for the augmented set of test cases 214 to detect and localize an n-wise or lesser order error based on those new test cases that yield a successful execution result. For example, a lesser order error can refer to an m-wise error where m<n, assuming complete n-wise coverage by the set of CTD vectors 206.

At block 402, a fault localization service determines whether any attribute is complete in the failing tests (e.g., whether every possible value for the attribute is present in the failing tests). If so, the flow proceeds to block 404 and the attribute is not the fault. If not, the flow proceeds to block 406.

In an embodiment, determining whether the attribute is complete in the failing tests provides a shortcut to determine that an attribute is not the cause of the fault. This works because we assume at least some tests pass. If an attribute has failed with every possible value, then the attribute must not be the source of the fault. The value of the attribute is independent from the success or failure of the test, and so the value of the attribute cannot be the cause of the fault.

At block 406, the fault localization service identifies one or more counterparts for the attribute combination in each failed test. For example, using the example of FIG. 2C described above, assume the test case 272 fails and the fault localization service is examining the attribute combination <Dale, blue>. The fault localization service identifies any counterparts to the combination <Dale, blue> in the set of test cases 270 (e.g., including the addition of the augmented test cases 276). As discussed above, there is guaranteed to be at least one counterpart to <Dale, blue>, because of the augmenting described above in relation to FIG. 3, but there may be more than one. In an embodiment, the fault localization service identifies each of the counterparts. In the example of FIG. 2C, the only counterpart to <Dale, blue> from the test case 272 is the test case 274.

At block 408, the fault localization service determines whether the counterpart succeeded. If so, the flow proceeds to block 404 and the attribute combination is not the cause of the fault. If not, the flow proceeds to block 410 and the fault localization service identifies the attribute combination as the fault.

Using our example of FIG. 2C again, the counterpart to the combination <Dale, blue> in the failing test 272 is in the test 274. But assume the test 274 also fails. Because the counterpart also fails, the fault localization service identifies the combination of <Dale, blue> as a fault.

Another example may also be instructive. Using the example from FIG. 2C, assume the fault localization service analyzes the combination <Dale, triangle> from the failing test case 272. At block 402, none of the attributes name, color, or shape, are complete in the failing tests, so the flow proceeds to block 406.

At block 406, the fault localization service identifies the counterpart to <Dale, triangle> as one of the augmented test cases 276: <Dale, green, triangle>. Assume <Dale, green, triangle> passes. At block 408, the fault localization service determines that this test case passes, and so <Dale, triangle> is not a fault. The augmenting of the set of test cases 270 with the augmented test cases 276 has allowed the fault localization service to rule out <Dale, triangle> as a fault. Stated more generally, and using the block diagram illustrated in FIG. 2A, the fault localization service can determine the specific attribute-value pairs that cause an n-wise or lesser order error based on an assessment of the execution results 218 for the augmented set of test cases 214.

Double n-Wise Test Solution with Constraints

Again, in an ideal situation, all possible sets of attribute values would be tested. However, this is often impractical, and thus a set of test cases may be generated, e.g., according to the methodology presented above with reference to 208 and 210 of FIG. 2A. As above, “n” used in this section may have any value, e.g., 2, 3, 4, 5, etc. For convenience, much of the description below refers to pairwise testing, looking at pairs of attribute values in a given test. Likewise, as above, if the requisite counterpart test (double) having the same set of n attribute values is not found for each test in the initial set of test cases, one or more augmented tests having the n attribute values are generated by the test case augmenter to create the missing counterpart(s).

In some cases, it may be desirable to define constraints that prevent testing using test cases that are undesirable for some reason, e.g., due to impracticality, impossibility, unlikelihood to encounter such set of attributes in the real world, and so on.

This section describes a double n-wise test solution that allows for the use of such constraints.

Illustrative constraints may define sets of attribute values that are not valid, e.g., not possible, not pertinent for testing, may be safely omitted for some reason such as that set of attribute values is unlikely to be found in the real world or pertinent to the current problem being addressed, etc.

Exemplary methods that use constraints are presented below.

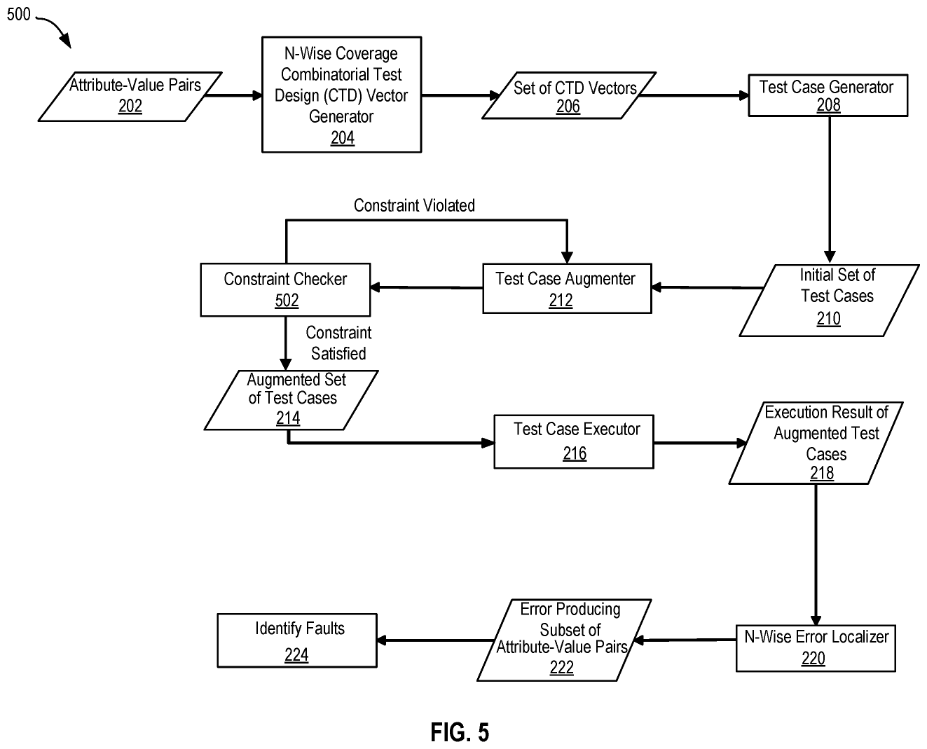

Now referring to FIG. 5, there is shown a block diagram 500 of a fault detection process using combinatorial testing and constraints, according to one embodiment. The process may be performed in accordance with the present invention in any of the environments depicted in FIGS. 1-4, among others, in various embodiments. Of course, more or fewer operations than those specifically described in FIG. 5 may be included in the process, as would be understood by one skilled in the art upon reading the present descriptions.

Each of the modules of the block diagram 500 may be implemented in and/or performed by any suitable component of the operating environment. For example, in various embodiments, the operations of the modules may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the block diagram 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, block diagram 500 includes modules 202-210, in which a set of test cases for a SUT are generated, the set of test cases being based on attribute-value pairs modeled as input to the SUT. The operations associated with modules 202-210 may be as described above with reference to FIG. 2A, in the manner described above.

Referring to modules 212, 502, 214 of FIG. 5, the set of test cases is augmented. In general, the test case augmenter 212 may be as described above with reference to FIG. 2A. For example locating the missing counterpart for the first combination of values may include identifying the first combination of values in the first test case, and determining that the set of test cases comprises an insufficient number of instances of test cases with the first combination of values. In one approach, the first combination of values comprises a first pair of values, and determining that the set of test cases comprises the insufficient number of instances of test cases includes determining that the set of test cases comprises fewer than two instances of test cases with the first pair of values. Moreover, generating the new test case based on modifying the first test case to act as the missing counterpart may include modifying a value in the first test case, other than the first pair of values. Additionally, the set of test cases may be augmented by adding a second new test case, based on locating a second missing counterpart for a second combination of values, that is different from the first combination of values, in the first test case.

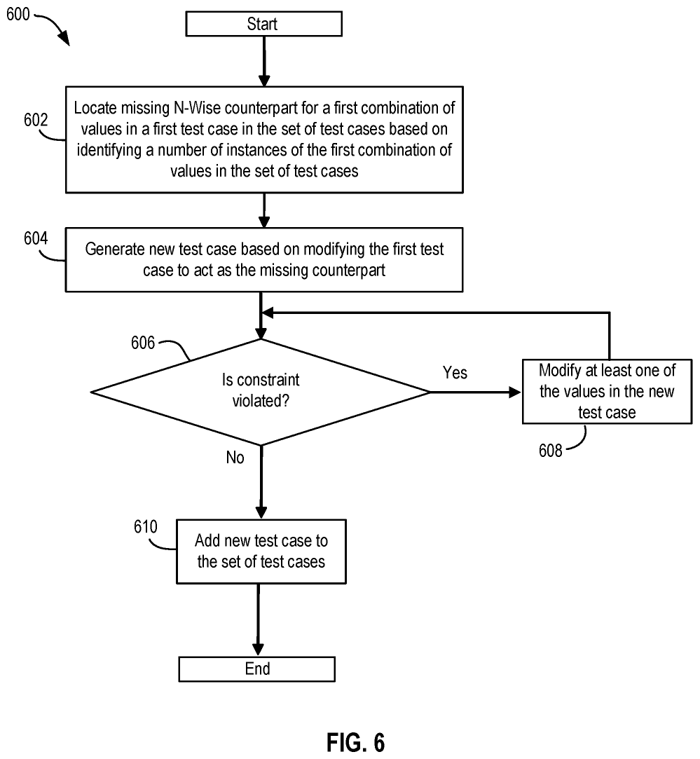

The constraint checker 502 checks the augmented test cases against the predefined constraints to ensure that the augmented test cases generated by the test case augmenter 212 do not violate any of the predefined constraints. In one embodiment, the constraint checker 502 may perform the method of FIG. 6. In another embodiment, the constraint checker 502 also checks the initial test cases against the predefined constraints to ensure that the initial test cases do not violate any of the predefined constraints.

Now referring to FIG. 6, a flowchart of a method 600 for augmenting a set of test cases in accordance with constraints is shown according to one embodiment. The method 600 may be performed in accordance with the present invention in any of the environments depicted in FIGS. 1-5, among others, in various embodiments. Of course, more or fewer operations than those specifically described in FIG. 6 may be included in method 600, as would be understood by one skilled in the art upon reading the present descriptions.

Each of the steps of the method 600 may be performed by any suitable component of the operating environment. For example, in various embodiments, the method 600 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where a missing counterpart for a first combination of values in a first test case in the set of test cases is located based on identifying a number of instances of the first combination of values in the set of test cases.

In operation 604, a new test case is generated based on modifying the first test case to act as the missing counterpart.

At decision 606, a determination is made as to whether the new test case violates a constraint from a set of predefined constraints. If the new test case violates a constraint, the method continues to operation 608. If the new test case does not violate a constraint, the method continues to operation 610.

The constraints may be predefined (e.g., taken from a table, defined by a user, etc.), determined using a trained machine learning model based on characteristics of the SUT, etc.

As noted above, constraints may define sets of attribute values that are not valid, e.g., not possible, not pertinent for testing, may be safely omitted for some reason such as that set of attribute values is unlikely to be found in the real world or pertinent to the current problem being addressed, etc.

As an example of a constraint, assume a computer system has 40 terabytes (TB) of memory but uses 24 bit addressing. Because 24 bit addressing cannot address 40 TB of memory, the attribute value pair of <24 bit addressing;40 TB memory> is not valid, and so should not be used in the testing.

As another example, assume the testing deals with vehicle performance with different grades of fuel, and thus, assume the attributes include the following attribute values: vehicles and fuel type. Attribute values having gas-powered vehicles should not be paired with a diesel fuel attribute value, as diesel fuel is not compatible with gas-powered vehicles. Accordingly, a constraint may dictate that attribute value pairs of a vehicle and an incompatible fuel are invalid. Going further, certain vehicles require premium gasoline. Accordingly, a constraint may specify that a test listing a premium-only gasoline powered vehicle matched with non-premium gasoline or diesel fuel is invalid. Similarly, to reduce testing cycles, a constraint may specify that an attribute value of a low-performance vehicle paired with an attribute value for racing fuel is invalid and thus should not be tested, because it is highly unlikely that such vehicle would be used in the real world with racing fuel.

The determination at decision 606 may be made in any manner that would become apparent to one skilled in the art upon reading the present disclosure. For example, sets (e.g., pairs, triples, etc.) of the attribute values may be compared to the constraints to determine if the sets violate any of the constraints.

In response to determining that the new test case violates the constraint, at least one of the values in the new test case is modified in operation 608. The modified test case is again assessed at decision 606 to determine whether the modified new test case again violates one or more of the predefined constraints. In response to determining that the modified new test case again violates one of the constraints, an attribute value in the modified new test case is altered prior to adding the modified new test case to the set of test cases. The assessment at decision 606 and modification at operation 608 continue to iterate through new values until the new test case is found to not violate any of the predefined constraints. The attribute value that is modified may be the same attribute value that was modified in the previous iteration, or a different attribute value.

If it is found that all attribute/value combinations created to generate a modified test case (to pair with a test having a missing pair) violate the list of constraints, then the original test case remains as a singleton without a pair. Thus, in response to determining that the modified new test case cannot be further modified to avoid violating all of the constraints in the set of constraints, e.g., because all values have been tried and the modified test case still violates one or more constraints, the modified new test case is not added to the set of set of test cases. The process is still able to debug faults at the n-wise level because there are no other tests to pair with the singleton. If the testing of the singleton fails, then the failing test is deemed to contain the bug.

In operation 610, the new test case is added to the set of test cases, e.g., to the augmented set of test cases 214 of FIG. 5.

Note that operations 602-610 may be repeated in iterations until no additional missing counterparts are located. Thus, in one approach, the augmented set of test cases is used to identify a next missing counterpart, in iterations using the augmented set of test cases generated in the previous iteration, until no additional counterparts are located. In an embodiment, the fault localization service uses the augmented set of test cases, including test cases added by the previous pass through blocks 602-610 to identify missing counterparts. Building the set of test cases in this way can have significant advantages, because each iteration through operations 602-610 adds augmented counterparts that apply to not only the pair under analysis, but potentially other pairs as well. For example, adding <Dale, green, triangle>, as discussed above, adds a counterpart for <Dale, triangle>, and also adds a counterpart for <Dale, green>, and for <green, triangle>. If either of those attribute pairs was previously missing a counterpart in the set of test cases, the counterpart will no longer be missing. Thus, the number of augmented test cases drops significantly as the fault localization service iterates through the attribute combinations in operations 602-610.

Referring again to FIG. 5, the process continues with identifying a fault for the SUT based on executing the augmented set of test cases. See modules/operations 216-224, which may operate as described for modules/operations 216-224 of FIG. 2A, and may implement the method of FIG. 4.

For example, in one approach, identifying the fault for the SUT based on executing the augmented set of test cases may include determining a particular combination of values that causes the fault.

In another approach, identifying the fault for the SUT based on executing the augmented set of test cases includes identifying a second combination of values in a failing test case. A counterpart test case for the failing test case, in the augmented set of test cases, is located. The counterpart test case may include the same second combination of values as the failing test case. In response to determining that the counterpart test case fails, the second combination of values may be identified as the fault.

In yet another approach, identifying the fault for the SUT based on executing the augmented set of test cases may include identifying a second combination of values in a failing test case. A counterpart test case for the failing test case, in the augmented set of test cases, is located, the test case including the same second combination of values as the failing test case. In response to determining that the counterpart test case succeeds, the second combination of values is determined not to be the fault.

As an example of implementation of the process shown in FIG. 5, assume an initial test includes the following values: <Cat; Bob;Triangle;Red;3>. However, the attribute pair for the name/color attribute values (Bob/Red) is missing a pair. Also assume the following two constraints apply: Bob and Dog are mutually exclusive; Bob and Star are mutually exclusive. The test case augmenter 212 varies one of the non-name/color attributes to generate the following augmented test: <Dog;Bob;Triangle;Red;3>. However, the constraint checker 502 determines that this augmented test violates the first constraint because it includes Dog and Bob. Accordingly, the test case augmenter 212 is instructed to generate another test. The test case augmenter 212 generates the following augmented test: <Cat;Bob;Star;Red;3>. However, the constraint checker 502 determines that this augmented test violates the second constraint because it includes Dog and Star. Accordingly, the test case augmenter 212 is instructed to generate yet another test. The test case augmenter 212 generates the following augmented test: <Cat;Bob;Triangle;Red;1>. This augmented test is valid per the constraints, and is added to the augmented set of test cases as the missing pair for the initial test.

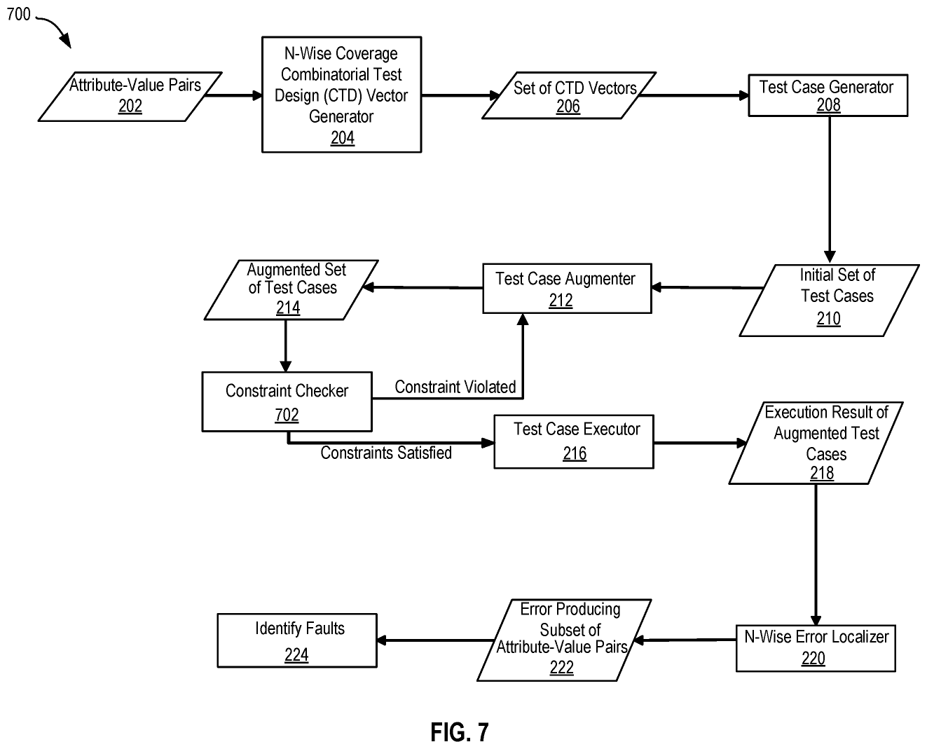

In the process of FIG. 5, the augmented test cases are checked prior to being added to the augmented set of test cases 214. In another approach, the augmented set of test cases 214 may be generated first, and then checked against the constraints. See the description of FIG. 7, below.

Likewise, if no pair is able to be made for the initial test of <Cat;Bob;Triangle;Red;3>, e.g., because all possibilities violate constraints, then that pair may be noted as special, and if the test having the pair fails, it is presumed to have a bug.

Now referring to FIG. 7, there is shown a block diagram 700 of a fault detection process using combinatorial testing and constraints, according to one embodiment. The process may be performed in accordance with the present invention in any of the environments depicted in FIGS. 1-6, among others, in various embodiments. Of course, more or fewer operations than those specifically described in FIG. 7 may be included in the process, as would be understood by one skilled in the art upon reading the present descriptions.

Each of the modules of the block diagram 700 may be implemented in and/or performed by any suitable component of the operating environment. For example, in various embodiments, the operations of the modules may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the block diagram 700. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 7, block diagram 700 includes modules 202-210, in which a set of test cases for a SUT are generated, the set of test cases being based on attribute-value pairs modeled as input to the SUT. The operations associated with modules 202-210 may be as described above with reference to FIG. 2A, in the manner described above.

Referring to modules 212, 214 of FIG. 7, the set of test cases is augmented. In general, the test case augmenter 212 and augmented set of test cases 214 may be as described above with reference to FIGS. 2-3 and 5. For example, illustrative operations for augmenting the test cases may include locating missing counterparts for combinations of values in multiple test cases in the set of test cases based on identifying numbers of instances of the combinations of values in the set of test cases, generating new test cases based on modifying the test cases having missing counterparts to act as the missing counterparts, and adding the new test cases to the set of test cases.

The constraint checker 702 checks the test cases in the augmented set of test cases 214 against predefined constraints to ensure that the test cases, such as the initial test cases and/or the augmented test cases generated by the test case augmenter 212, do not violate any of the predefined constraints. Thus, as alluded to in the previous sentence, the determination of whether one or more of the test cases in the augmented set of test cases violates the one or more constraints is only performed on the new test cases in some approaches. For example, this feature may be used when the test cases in the original set are all presumed valid.

The constraint checker 702 may operate in a similar manner as the constraint checker 502 of FIG. 5. Likewise, the constraints may be as described above.

With continued reference to FIG. 7, in response to determining that one of the test cases in the augmented set of test cases violates one or more of the constraints, at least one of the values in the one of the test cases is modified, thereby effectively replacing the test case that violated one of the constraints with a modified test case. As shown in FIG. 7, the constraint checker 702 may send a request to the test case augmenter 212 to generate a modified test case, and the constraint checker 702 verifies the modified test case again for compliance with the constraints.

In response to determining that one of the test cases violates one or more of the constraints, at least one of the values in that test case is modified. The modified test case is again assessed by the constraint checker to determine whether the modified test case again violates one or more of the predefined constraints. In response to determining that the modified test case again violates one of the constraints, an attribute value in the modified test case is altered again and re-checked. The assessment at decision 606 and modification at operation 608 continue to iterate through new values until a modified test case is found to not violate any of the predefined constraints. The attribute value that is modified may be the same attribute value that was modified in the previous iteration, or a different attribute value.

If it is found that all attribute/value combinations created to generate a modified augmented test case (to pair with a test having a missing pair) violate the list of constraints, then the original test case remains as a singleton without a pair. Thus, in response to determining that the modified test case cannot be further modified to avoid violating all of the constraints in the set of constraints, e.g., because all values have been tried and the modified test case still violates one or more constraints, the modified test case is not tested, e.g., by the test case executor 216. The process may still be able to debug faults at the n-wise level if the initial test case exists as a singleton, because there are no other tests to pair with the singleton. If the test of the singleton fails, then the failing test is deemed to contain the bug.

With continued reference to FIG. 7, the process continues with identifying a fault for the SUT based on executing the augmented set of test cases. See modules 216-224, which may operate as described for modules 216-224 of FIG. 2, and may implement the method of FIG. 4.

For example, in one approach, identifying the fault for the SUT based on executing the augmented set of test cases may include determining a particular combination of values that causes the fault.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a set of test cases for a system under test (SUT), the set of test cases being based on attribute-value pairs modeled as input to the SUT;
augmenting the set of test cases, comprising:
locating a missing counterpart for a first combination of values in a first test case in the set of test cases based on identifying a number of instances of the first combination of values in the set of test cases,
generating a new test case based on modifying the first test case to act as the missing counterpart,
determining whether the new test case violates a constraint from a set of predefined constraints,
in response to determining that the new test case violates the constraint, modifying at least one of the values in the new test case, and
adding the modified new test case to the set of test cases; and
identifying a fault for the SUT based on executing the augmented set of test cases.

2. The method of claim 1, comprising: determining whether the modified new test case violates one or more of the predefined constraints; and in response to determining that the modified new test case violates one of the constraints, again modifying at least one of the values in the modified new test case prior to adding the modified new test case to the set of test cases.

3. The method of claim 2, comprising:
in response to determining that the modified new test case cannot be further modified to avoid violating all of the constraints in the set of constraints, not adding the modified new test case to the set of set of test cases.

4. The method of claim 1, wherein locating the missing counterpart for the first combination of values further comprises:
identifying the first combination of values in the first test case; and
determining that the set of test cases comprises an insufficient number of instances of test cases with the first combination of values.

5. The method of claim 4,
wherein the first combination of values comprises a first pair of values; and
wherein determining that the set of test cases comprises the insufficient number of instances of test cases comprises determining that the set of test cases comprises fewer than two instances of test cases with the first pair of values.

6. The method of claim 5, wherein generating the new test case based on modifying the first test case to act as the missing counterpart further comprises:
modifying a value in the first test case, other than the first pair of values.

7. The method of claim 6, further comprising:
augmenting the set of test cases by adding a second new test case, based on locating a second missing counterpart for a second combination of values, different from the first combination of values, in the first test case.

8. The method of claim 1, wherein identifying the fault for the SUT based on executing the augmented set of test cases comprises determining a particular combination of values that causes the fault.

9. The method of claim 1, wherein identifying the fault for the SUT based on executing the augmented set of test cases comprises:
identifying a second combination of values in a failing test case;
locating a counterpart test case for the failing test case, in the augmented set of test cases, wherein the counterpart test case comprises the same second combination of values as the failing test case; and
determining that the counterpart test case fails, and in response identifying the second combination of values as the fault.

10. The method of claim 1, wherein augmenting the set of test cases comprises: repeating in iterations until no additional missing counterparts are located, using the augmented set of test cases to identify a next missing counterpart.

11. A computer program product for double n-wise testing, the computer program product comprising:
one or more computer readable storage media, and program instructions collectively stored on the one or more computer readable storage media, the program instructions comprising:
program instructions to generate a set of test cases for a system under test (SUT), the set of test cases being based on attribute-value pairs modeled as input to the SUT;
program instructions to augment the set of test cases, comprising:
locating a missing counterpart for a first combination of values in a first test case in the set of test cases based on identifying a number of instances of the first combination of values in the set of test cases,
generating a new test case based on modifying the first test case to act as the missing counterpart,
determining whether the new test case violates a constraint from a set of predefined constraints,
in response to determining that the new test case violates the constraint, modifying at least one of the values in the new test case, and
adding the modified new test case to the set of test cases; and
program instructions to identify a fault for the SUT based on executing the augmented set of test cases.

12. A system, comprising:
a processor; and
logic integrated with the processor, executable by the processor, or integrated with and executable by the processor, the logic being configured to perform the method of claim 1.

13. A computer-implemented method, comprising:
generating a set of test cases for a system under test (SUT), the set of test cases being based on attribute-value pairs modeled as input to the SUT;
augmenting the set of test cases, comprising:
locating missing counterparts for combinations of values in multiple test cases in the set of test cases based on identifying numbers of instances of the combinations of values in the set of test cases,
generating new test cases based on modifying the test cases having missing counterparts to act as the missing counterparts,
adding the new test cases to the set of test cases;
determining whether one or more of the test cases in the augmented set of test cases violates one or more constraints from a set of predefined constraints;
in response to determining that one of the test cases in the augmented set of test cases violates one or more of the constraints, modifying at least one of the values in the one of the test cases; and
identifying a fault for the SUT based on executing the augmented set of test cases.

14. The method of claim 13, wherein the determining whether one or more of the test cases in the augmented set of test cases violates the one or more constraints is only performed on the new test cases.

15. The method of claim 13, comprising: determining whether the one of the test cases with the at least one modified value violates one or more of the predefined constraints; and in response to determining that the one of the test cases with the at least one modified value violates one of the constraints, again modifying at least one of the values in the test case with the at least one modified value.

16. The method of claim 15, comprising:
in response to determining that the one of the test cases cannot be further modified to avoid violating all of the constraints in the set of constraints, not testing the one of the test cases.

17. The method of claim 13, wherein locating the missing counterpart for a first of the combinations of values further comprises:
identifying a first of the combinations of values in a first of the test cases; and
determining that the set of test cases comprises an insufficient number of instances of test cases with the first combination of values.

18. The method of claim 13, wherein identifying the fault for the SUT based on executing the augmented set of test cases comprises determining a particular combination of values that causes the fault.

19. A computer program product for double n-wise testing, the computer program product comprising:
one or more computer readable storage media, and program instructions collectively stored on the one or more computer readable storage media, the program instructions comprising program instructions to perform the method of claim 13.

20. A system, comprising:
a processor; and
logic integrated with the processor, executable by the processor, or integrated with and executable by the processor, the logic being configured to perform the method of claim 13.
